(19) United States
(12) Patent Application Publication
(10) Pub. No.: US 2010/0260594 A1
(43) Pub. Date: Oct. 14, 2010

(54) VACUUM LINE

(75) Inventor: Heinrich Englaender, Linnich (DE)

Correspondence Address: FAY SHARPE LLP, 1228 Euclid Avenue, 5th Floor, The Halle Building, Cleveland, OH, 44115, US

(73) Assignee: OERLIKON LEYBOLD VACUUM GMBH, Koeln (DE)

(21) Appl. No.: 12/528,178

(22) PCT Filed: Jan. 14, 2008
(86) PCT No.: PCT/EP2008/050336

§ 371 Date: Aug. 21, 2009

(30) Foreign Application Priority Data
Feb. 23, 2007 (DE) 10 2007 008 859.2

(51) Int. Cl. F04D 29/66; F16L 19/00

(52) U.S. Cl. 415/119; 285/123.3

(57) ABSTRACT

A vacuum line (10) includes two line parts (12, 13) connected by a vibration damper (14). The vibration damper (14) is formed by a vertical outer pipe (18) and a vertical inner pipe (20) spaced from the outer pipe (18). A flexible tension sleeve (30) is fastened between opening edges (19, 42) of the outer pipe (18) and the inner pipe (20). The tension sleeve establishes a vacuum-tight connection of opening edges (19, 42) of the outer pipe (18) and the inner pipe (20).

The invention refers to a vacuum line comprising two line parts connected by a vibration damper.

In the field of vacuum technology, vibration dampers are used to decouple vibrations in a vacuum connection, especially when the transmission of vibrations generated by a vacuum pump to a connected vibration-sensitive recipient, e.g. an electron microscope, is or has to be avoided.

A turbomolecular vacuum pump is known from DE 100 01 509 A1, which comprises a high vacuum flange decoupled from the pump part by means of a vibration damper. The vibration damper is a corrugated metal bellows with a separate external supporting rubber sheath. The rubber sheath supports the high vacuum flange axially against the pump part and is thus rather rigid. Thus, the transmission of vibrations is dampened only to a rather limited extent, which may substantially affect the function of a sensitive apparatus connected to the high vacuum flange, e.g. an electron microscope.

In view of this, it is an object of the invention to provide a vacuum line comprising a vibration damper having improved damping properties.

This object is achieved, according to the invention, with a vacuum line or a vacuum pump with the features of claims 1 and 8, respectively.

In the vacuum line of the present invention, two line parts that have limited mobility relative to each other, are joined by the vibration damper in a vacuum-tight and non-rigid manner. Associated to the two line parts thus joined is a respective pipe, namely a vertical outer pipe is associated to the one line part, whereas a vertical inner pipe is associated to the other line part. The inner pipe is set into the outer pipe with a radial distance therebetween. Thus, the outer pipe and the inner pipe overlap axially along an overlapping length. Spanned between the two corresponding pipe opening edges is a flexible tension sleeve having its opening edges preferably fastened to the opening edges of both pipe ends, thereby establishing a vacuum-tight tensile connection between the two pipes. In the present context, “tension sleeve” means that the sleeve is subjected to tension when both pipes are pushed axially into each other, e.g. by differential pressures outside and inside the vacuum line. In longitudinal section, the two pipes and the tension sleeve have a N-shaped contour, the diagonal being formed by the tension sleeve.

By telescoping the inner tube and the outer tube, a very compact structure of the vibration damper is realized. Since the tension sleeve receives the axial forces generated by the differential pressure and thereby limits the axial approach or overlapping of the two pipes to a maximum value, no further means are required to avoid a direct axial contact between both line parts. D depending on the elasticity of the material, the tension sleeve may be drawn upon the occurrence of a drop of pressure between the exterior and the interior of the vacuum line, but the tension sleeve is at the same time at least slightly bulged toward the vacuum side by the differential pressure so that the effective axial length or projection of the tension sleeve is reduced again.

With a tension sleeve configured almost as an axial hose, transverse vibrations are damped to a very great extent or not transmitted, whereas longitudinal vibrations are damped only by the elasticity of the tension sleeve. The same is almost true for the inverse, if the sleeve length is small as compared to the sleeve width.

Upon the presence of a partial vacuum or a vacuum in the vacuum line, the tension sleeve has an axial preferential direction. Here, the tension sleeve is inclined preferably by less than 45°, and especially preferred by less than 20°, to the axial line, i.e. the mean conicity is less than 45° or 20°, respectively. The chosen cone angle of down to 0° with respect to the axial line depends, among other factors, on the spatial axis in which the vibrations to be decoupled lie or are to be dampened.

Preferably, the axial length of the sleeve is at least twice the radial width of the sleeve. In this manner, it is possible for the tension sleeve to receive relatively great axial forces due to the differential pressure between the exterior and the interior of the vacuum line. By a relatively great sleeve length or a relatively small cone angle of the tension sleeve, the transmission of, in particular, radial vibrations is damped in a large extent or avoided. This is of high importance especially if one of the two line parts is connected to a machine rotating at high speeds, e.g. a turbo-pump, which particularly generates radial vibrations.

In a preferred embodiment, the tension sleeve has at least one cavity adapted to be filled with a fluid. The fluid used may a gas or a liquid. The cavity may extend over a part or the entire length of the tension sleeve and, circularly, over a part of or the entire circumference of the tension sleeve. A plurality of separated cavities could also be provided.

By filling the tension sleeve cavity with different fluids, the damping properties of tension sleeve can be changed. For example, the damping properties can thus be set permanently as a function of the respective marginal conditions prevailing.

A sleeve control can be provided that controls the amount of fluid in the cavity in dependence on the operational condition. In this manner, the damping properties of the vacuum line can be changed during operation. Complementarily, the sleeve control may also control the length of the tension sleeve. In this manner, a rigid tension sleeve may be set, for example, at the start-up of a high-speed rotary vacuum pump. As an alternative, it is also possible to temporarily set a non-damped, direct mechanical coupling of the two line parts at start-up, for example, by emptying the cavity. This is sensible, for example, when decoupling an electron microscope from vibrations generated by a turbomolecular vacuum pump, which requires a very low-frequent tuning of the vibration damper for an operation at the rated rotational speed of the turbomolecular pump. A very low-frequent tuning of the vibration damper may, however, cause instabilities and resonance phenomena when the turbomolecular pump ramps up. Thus, the sleeve control allows for a hard, non-damped coupling of the two line parts during ramp-up, and allows the vibration damper to be used after ramp-up, by filling the tension sleeve cavity with fluid.

The tension sleeve cavity may further act as a pad in the radial space between the inner pipe and the outer pipe, which damps the radial relative movements between the inner pipe and the outer pipe or prevents the inner pipe from directly contacting the outer pipe.

In a preferred embodiment, a compression stop and/or a tension stop may be provided. On the one hand, the compression stop may be used as a purposefully rigid connection of both line parts, for example, when ramping up a turbomolecular pump. The compression stop further limits the axial approach of both line parts, for example, in case of a damage of the tension sleeve, upon a hard axial impact, etc. The tension stop may, for example, serve to take up weight forces and the like during times of non-operation, i.e., especially if a pressure balance prevails between the inside and the outside of the vacuum line.

According to the independent claim 8, a vacuum pump is connected to a recipient via a vibration damper, the vibration damper comprising the features of claims 1 to 7.

Preferably, the vacuum pump is a turbomolecular pump and the recipient is an electron microscope. Electron microscopes are extremely sensitive to oscillations and vibrations, which cannot be avoided in the operation of a turbomolecular pump. The vibration damper described is particularly suited for decoupling the turbomolecular pump from the electron microscope.

Hereinafter, two embodiments of the invention are described in detail with reference to the drawings.

In the Figures:

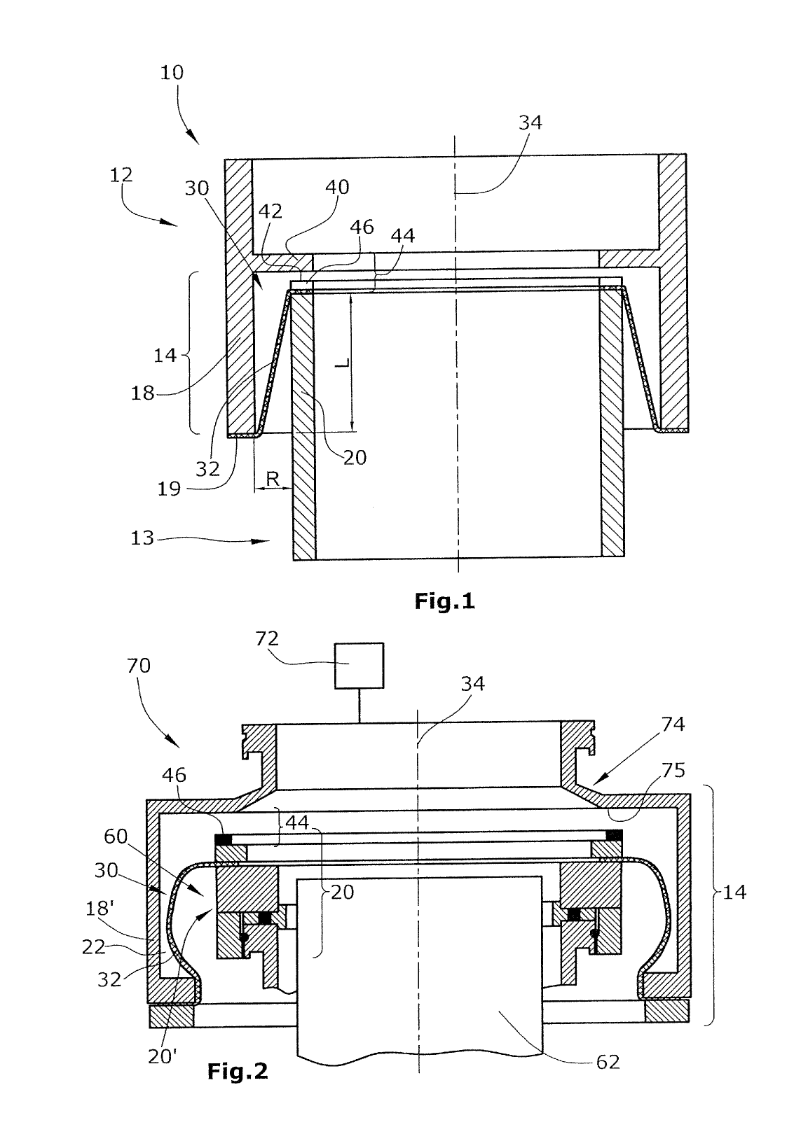

FIG. 1 shows a vacuum line in longitudinal section, the line comprising two line parts connected by means of a vibration damper,

FIG. 2 illustrates a turbomolecular pump connected to an electron microscope and comprising a vibration damper for connecting the turbomolecular pump with the electron microscope, and

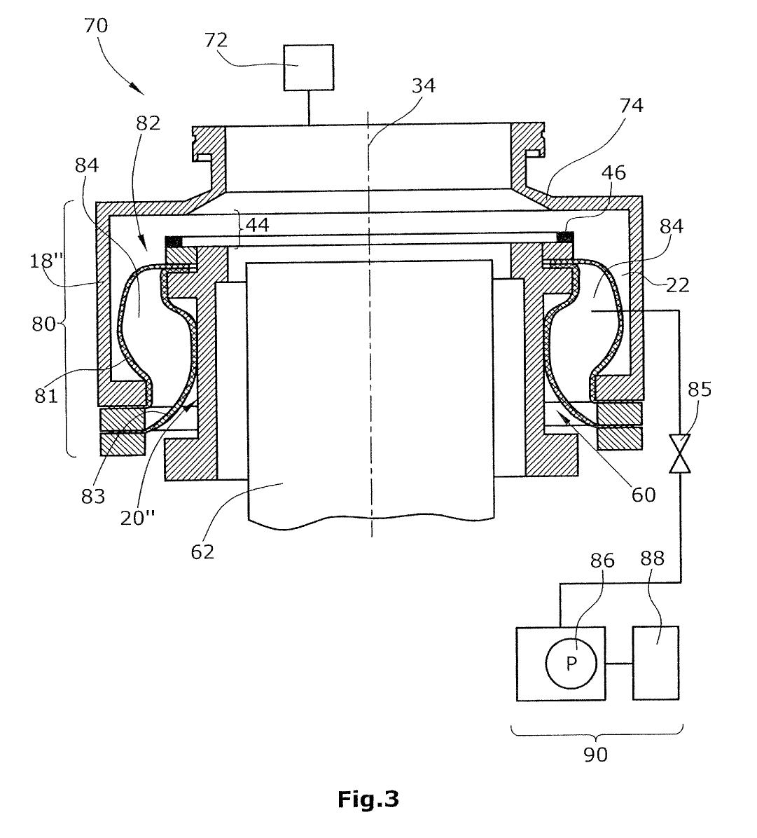

FIG. 3 shows the arrangement of FIG. 2 with a second embodiment of a vibration damper provided with a cavity.

FIG. 1 schematically shows one part of a vacuum line 10 formed by two line parts 12, 13 interconnected via a vibration damper 14. In the operating state, a sub-atmospheric pressure prevails in the vacuum line 10, whereas atmospheric pressure prevails outside the vacuum line 10.

The upper line part 12 comprises a vertical outer pipe 18 into which a vertical inner pipe 20 is fitted. The diameters of the outer pipe 18 and the inner pipe 20 may be circular, but need not be so. The sectional profile of the outer tube and the inner tube 18, 20 may be cylindrical, but need not be so.

The opening edge 42 of the inner pipe 20 and the opening edge 19 of the outer pipe 18 are connected via a flexible tension sleeve 30 formed by a flexible, yet not or not very elastic sleeve hose 32. The opening edges of the sleeve hose 32 are connected in a vacuum-tight manner with the respective opening edges 19, 42 of the outer pipe and the inner pipe 18, 20. This may be effected, for example, through appropriate screwed clamping rings and/or by glueing.

The inner pipe 20 and the outer pipe 18 are spaced by a radial distance which, in the present instance, approximately corresponds to the radial sleeve width R in the profile section of the tension sleeve 30. The inner pipe 20 is set into the outer pipe 18 by an overlapping length which, in the present instance, approximately corresponds to the axial length L of the sleeve. The length L of the sleeve is a multiple of the radial sleeve width R so that the tension sleeve 30 or the sleeve hose 32 is inclined under an angle of less than 20° with respect to the axial line 34, if no differential pressure exists between the inside and the outside of the vacuum line 10. Should a differential pressure exist, the sleeve hose 32 bulges distally in the direction of the vacuum, the mean angle of the sleeve hose 32 remaining unchanged. The space for the distal bulging of the tension sleeve is possibly provided by a circular radial expansion space 22 of the outer pipe 18.

The inner side of the outer pipe 18 is provided with a radially inward projecting shoulder ring 40 which forms a tension stop 44 together with the opening edge 42 of the inner pipe 20, the tension stop limiting the movement of the inner pipe 20 into the outer pipe 18. For cushioning a corresponding impact movement of the inner pipe 20 against the outer pipe 18, the opening edge 42 of the inner pipe is provided with a corresponding flexible and elastic stop ring 46.

FIG. 2 illustrates an arrangement comprising a vacuum pump 60 and a recipient 70. The recipient 70 comprises an electron microscope 72 connected in a vacuum-tight manner to a damper housing 74 which in turn accommodates the outer pipe 18 enclosing the expansion space 22.

The vacuum pump 60 is a turbomolecular pump with a pump rotor 62 and comprises a plurality of annular components at its intake side, which, on the one hand, form a housing of the vacuum pump or the rotor 62, and, on the other hand, form the non-cylindrical inner pipe 20 for the vibration damper 14.

As is well obvious from FIG. 2, the present vibration damper 14 allows for a very compact structure, since the vibration damper 14 is arranged essentially radially outside around the suction-side end of the vacuum pump 60.

FIG. 2 illustrates the situation in the presence of a substantial differential pressure between the inside and the outside of the illustrated arrangement 70. Due to the differential pressure, the sleeve hose 32 bulges radially outward toward the vacuum, whereby the vacuum pump 60 slightly moves axially away from the damper housing 74. By this effect it is possible for the vacuum pump 60, in the event of no or a little pressure difference, to rest on a corresponding front end face 75 of the damper housing 74 by elastically deformable stop ring 46. Thus, when the vacuum pump 60 is ramped up, an non-damped rigid mechanical coupling exists between the vacuum pump 60 and the recipient 72. Only upon a corresponding vacuum does the vacuum pump 60 move axially away from the damper housing 74 due to the distal bulging of the sleeve hose 32, so that only a well damped, non-rigid and vacuum-tight connection exists between the vacuum pump 60 and the damper housing 74.

In the present case, the vacuum pump 60 is a turbomolecular pump with a fast rotating rotor 62 rotating about the axial line 34. The rotor 62 substantially generates radial vibrations that are damped to a very large degree by the substantially axial orientation of the sleeve hose 32, since the outer pipe 18′ and the inner pipe 20′ can move radially relative to each other with almost no resistance.

FIG. 3 illustrates a second embodiment of a vibration damper 80. The vibration damper 80 has a tension sleeve 82 formed by two mutually concentric sleeve hoses 81, 83 which form a circular cavity 84 between them. If needed, the cavity 84 is filled with a gaseous fluid. To control the amount of fluid and the fluid pressure, a sleeve control 90 is provided which is substantially formed by a control module 88, a fluid pump 86 and a fluid valve 85.

By increasing or decreasing the fluid pressure or the amount of fluid in the tension sleeve cavity 84, the sleeve control 90 can set the axial distance between the vacuum pump 60 an the damper housing 74 and the damping parameter of the tension sleeve 82. If the tension sleeve cavity 84 is filled with fluid, the tension sleeve 82 further forms an annular cushion that prevents a radial abutment of the vacuum pump 60 against the damper housing 74 or of the outer pipe 18″ against the inner pipe 20″. The fluid used is a gas, e.g. ambient air. However, a liquid may also be used as the fluid.

1. A vacuum line comprising:
two line parts connected by a vibration damper and being movable relative to each other,
the vibration damper comprising:
a vertical outer pipe,
a vertical inner pipe inserted into the outer pipe, and
a flexible tension sleeve spanned between the inner and outer pipes and having opening edges vacuum-tightly fastened to the outer pipe and to the inner pipe.

2. The vacuum line of claim 1, wherein the tension sleeve is inclined by less than 45° with respect to a vertical axis when tensioned.

3. The vacuum line of claim 1, wherein a length of the tension sleeve is at least twice a radial width of the tension sleeve.

4. The vacuum line of claim 1, wherein the tension sleeve defines at least one tension sleeve cavity adapted to be filled with a fluid.

5. The vacuum line of claim 4, further including:
a sleeve control which controls an amount of fluid in the tension sleeve cavity in accordance with operating conditions.

6. The vacuum line of claim 5, further including:
a tension stop.

7. The vacuum line of claim 1, further including:
a compression stop.

8. An arrangement comprising:
a vacuum pump;
a recipient; and
the vibration damper of claim 1 connecting the vacuum pump and the recipient.

9. The arrangement of claim 8, wherein the vacuum pump is a turbomolecular pump and the recipient is an electron microscope.

10. The vacuum line of claim 2, wherein the tension sleeve is included at an angle of less than 20°.

11. A vibration damper which connects to line parts, the vacuum damper comprising:
a vertical outer pipe connected with a first of the line parts;
a vertical inner pipe received movably in the vertical outer pipe, the inner pipe being connected with a second of the line parts; and
a flexible tension sleeve connecting the inner and outer pipes with a flexible, fluid tight seal, the flexible tension sleeve having an outer edge connected to the outer pipe in a vacuum-tight manner and an inner edge connected to the inner pipe in a vacuum-tight manner.

12. The vibration damper of claim 11, wherein the flexible tension sleeve is conical when no vacuum is created in the line parts and flexes outward when a vacuum is created in the line parts.

13. The vibration damper of claim 11, wherein the flexible tension sleeve defines a fluid cavity.

14. The vibration damper of claim 13, further including:
a pressure assembly connected with the flexible tension sleeve cavity to adjust a stiffness of the flexible tension sleeve by adjusting a fluid pressure in the flexible tension sleeve cavity.

15. The vibration damper of claim 11, wherein the second one of the line parts includes a suction side of a vacuum pump.

16. The vibration damper of claim 14, wherein the first one of the line parts includes an electron microscope.
